(19) United States
(12) Patent Application Publication
(10) Pub. No.: US 2016/0068367 A1
(43) Pub. Date: Mar. 10, 2016

(54) Wrapped Paper Roll Clip Device

(71) Applicant: Jill Palmer, Streetboro, OH (US)

(72) Inventor: Jill Palmer, Streetboro, OH (US)

(21) Appl. No.: 14/478,133

(22) Filed: Sep. 5, 2014

(51) Int. Cl. B65H 75/28; F16B 2/10

(52) U.S. Cl. CPC B65H 75/285; F16B 2/10

(57) ABSTRACT

A wrapped paper roll clip device secures paper in a rolled position wrapped around a tube. The device includes a pair of arms pivotally coupled together. Each of the arms has a first section and a second section extending outwardly from a pivot point of the arms. The first sections are arcuate and oppositionally positioned defining a tubular channel therebetween. The second sections are spaced for being squeezed together to urge the first sections apart. A biasing member urges the first sections together and the second sections apart. Each of a pair of feet is coupled to and extends from a distal edge of an associated one of the first sections relative to the pivot point of the arms.

### BACKGROUND OF THE DISCLOSURE

### Field of the Disclosure

The disclosure relates to clip devices and more particularly pertains to a new clip device for securing paper in a rolled position wrapped around a tube.

SUMMARY OF THE DISCLOSURE

An embodiment of the disclosure meets the needs presented above by generally comprising a pair of arms pivotally coupled together. Each of the arms has a first section and a second section extending outwardly from a pivot point of the arms. The first sections are arcuate and oppositionally positioned defining a tubular channel therebetween. The second sections are spaced for being squeezed together to urge the first sections apart. A biasing member urges the first sections together and the second sections apart. Each of a pair of feet is coupled to and extends from a distal edge of an associated one of the first sections relative to the pivot point of the arms.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a wrapped paper roll clip device according to an embodiment of the disclosure.

FIG. 2 is a side view of an embodiment of the disclosure.

FIG. 3 is a front view of an embodiment of the disclosure.

FIG. 4 is a cross-sectional view of an embodiment of the disclosure taken along line 4-4 of FIG. 3.

FIG. 5 is a top front side perspective view of an embodiment of the disclosure in use.

### DESCRIPTION OF THE PREFERRED EMBODIMENT

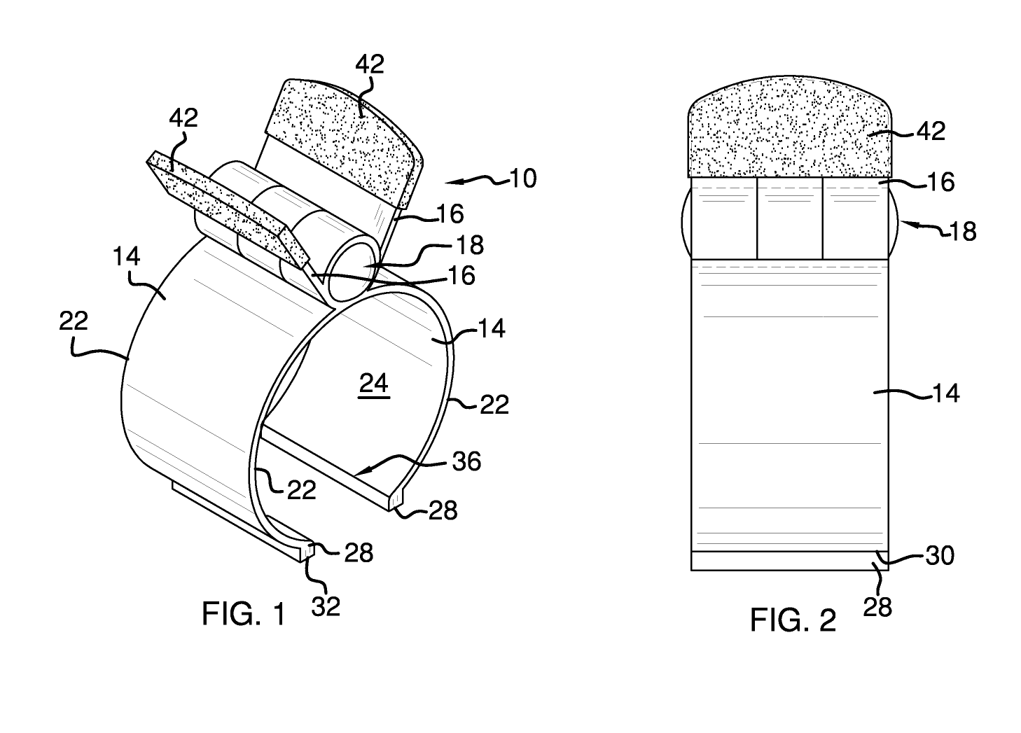

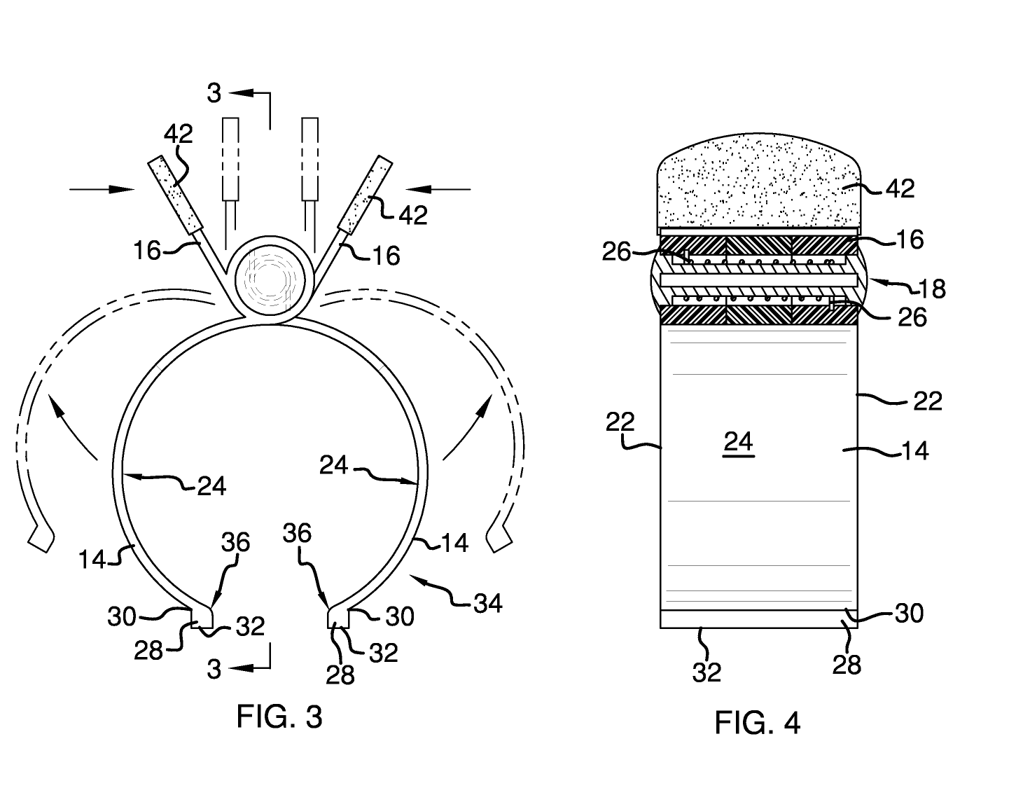

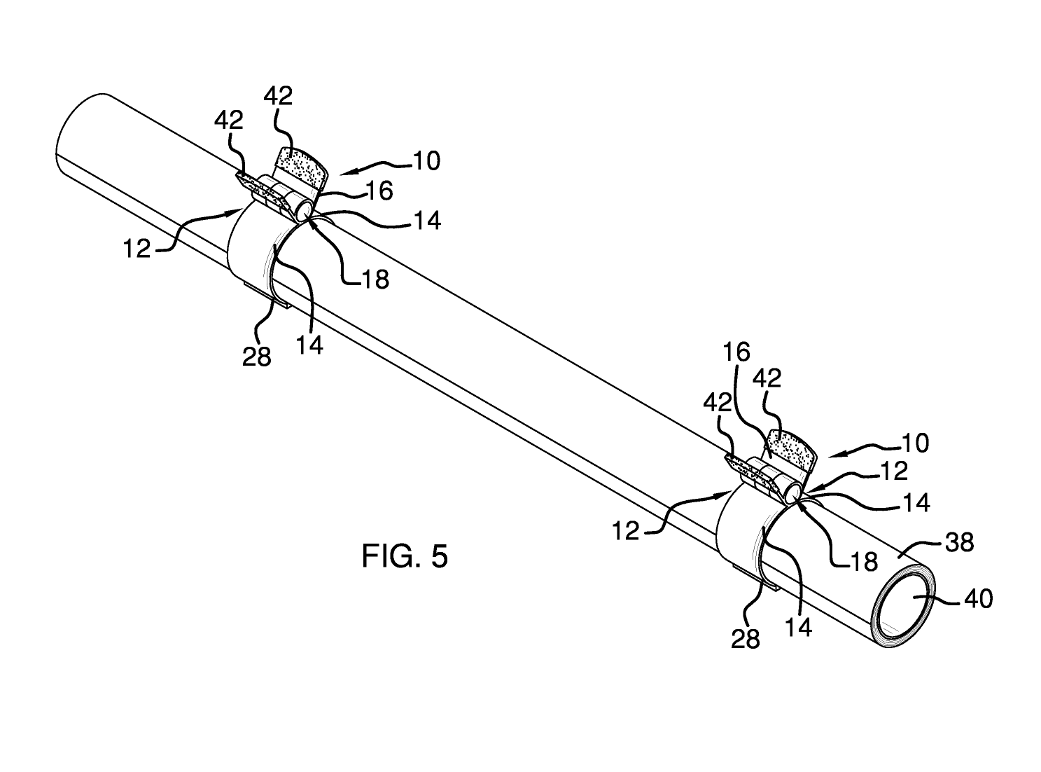

With reference now to the drawings, and in particular to FIGS. 1 through 5 thereof, a new clip device embodying the principles and concepts of an embodiment of the disclosure and generally designated by the reference numeral 10 will be described.

As best illustrated in FIGS. 1 through 5, the wrapped paper roll clip device 10 generally comprises a pair of arms 12 pivotally coupled together. Each of the arms 12 has a first section 14 and a second section 16 extending outwardly from a pivot point 18 of the arms 12. The first sections 14 are each arcuate and oppositionally positioned wherein the first sections 14 define a tubular channel 20 therebetween. The second sections 16 are positioned in spaced relationship wherein the second sections 16 are configured for being squeezed together whereby the first sections 14 are urged apart. Each first section 14 is continuous between respective lateral sides 22 of each first section 14. Thus, each first section 14 defines a single continuous smooth surface 24 extending from the pivot point 18 of the arms 12. Each of the second sections 16 of the arms is substantially planar. Each of a pair of pads 42 may be coupled to an associated one of the second sections 16 of the arms 12. Each of the second sections 16 may include contours, cutouts, borders, or the like, to create various designs or decorative shapes. A biasing member 26 is coupled to the arms 12. The biasing member 26 urges the first sections 14 together and the second sections 16 apart.

Each of a pair of feet 28 is coupled to and extends from a distal edge 30 of an associated one of the first sections 14 relative to the pivot point 18 of the arms 12. Each of the feet 28 has a distal face 32 relative to the pivot point 18 of the arms 12. The distal faces 32 of the feet 28 are substantially coplanar when the arms 12 are in a closed position 34. A respective junction 36 between each of the feet 28 and the distal edge 30 of the first sections 14 is rounded between the lateral sides 22 of the first sections 14 wherein the each junction 36 is configured to prevent snagging on wrapped paper 38 around a tube 40.

In use, the second sections 16 are grasped and pinched or squeezed together to expand the first sections 14 of the arms 12. The device 10 may then be positioned on the tube 40. The biasing member 26 urges the first sections 14 against the wrapped paper 38 preventing the wrapped paper 38 from coming off of the tube 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wrapped paper roll clip device for securing wrapped paper around a tube, the device comprising:
a pair of arms pivotally coupled together, each of said arms having a first section and a second section extending outwardly from a pivot point of said arms, said first sections being arcuate and oppositionally positioned wherein said first sections define a tubular channel therebetween, said second sections being positioned in spaced relationship wherein said second sections are configured for being squeezed together whereby said first sections are urged apart;
a biasing member coupled to said arms, said biasing member urging said first sections together and said second sections apart; and
a pair of feet, each said foot being coupled to and extending from a distal edge of an associated one of said first sections relative to said pivot point of said arms.

2. The device of claim 1, further comprising each of said feet having a distal face relative to said pivot point of said arms, said distal faces of said feet being substantially coplanar when said arms are in a closed position.

3. The device of claim 1, further comprising a respective junction between each of said feet and said distal edge of said first sections being rounded between lateral sides of said first sections wherein said each said junction is configured to prevent snagging on the wrapped paper.

4. The device of claim 1, further comprising each of said second sections of said arms being planar.

5. The device of claim 1, further comprising a pair of pads, each of said pads being coupled to an associated one of said second sections of said arms.

6. The device of claim 1, further comprising each said first section being continuous between respective lateral sides of each said first section wherein each said first section defines a single surface extending from said pivot point of said arms.

7. A wrapped paper roll clip device for securing wrapped paper around a tube, the device comprising:
a pair of arms pivotally coupled together, each of said arms having a first section and a second section extending outwardly from a pivot point of said arms, said first sections being arcuate and oppositionally positioned wherein said first sections define a tubular channel therebetween, said second sections being positioned in spaced relationship wherein said second sections are configured for being squeezed together whereby said first sections are urged apart, each said first section being continuous between respective lateral sides of each said first section wherein each said first section defines a single surface extending from said pivot point of said arms, each of said second sections of said arms being planar;
a biasing member coupled to said arms, said biasing member urging said first sections together and said second sections apart;
a pair of feet, each said foot being coupled to and extending from a distal edge of an associated one of said first sections relative to said pivot point of said arms, each of said feet having a distal face relative to said pivot point of said arms, said distal faces of said feet being substantially coplanar when said arms are in a closed position;
a respective junction between each of said feet and said distal edge of said first sections being rounded between lateral sides of said first sections wherein said each said junction is configured to prevent snagging on the wrapped paper; and
a pair of pads, each of said pads being coupled to an associated one of said second sections of said arms.
